(19) United States
(12) Patent Application Publication
(10) Pub. No.: US 2026/0298254 A1
(43) Pub. Date: Oct. 1, 2026

(54) COMPRESSOR ASSEMBLY

(71) Applicant: Siemens Energy Global GmbH & Co. KG, München (DE)

(72) Inventor: Kevin Miny, Essen (DE)

(21) Appl. No.: 19/489,352

(22) PCT Filed: Jun. 11, 2024
(86) PCT No.: PCT/EP2024/066026

§ 371 Date: Dec. 2, 2025

(30) Foreign Application Priority Data
Jun. 22, 2023 (DE) 10 2023 205 882.0

(51) Int. Cl. F04D 29/057; F04D 25/06

(52) U.S. Cl. CPC F04D 29/057; F04D 25/06

(57) ABSTRACT

The invention relates to a compressor device comprising a compressor unit designed for compressing flow media, the compressor unit comprising a rotatably mounted rotor and a housing arranged around the rotor, with gas bearings designed for supporting the rotor, the gas bearing being operable by a flow medium, wherein a fluidic connection is arranged between the gas bearing and the compressor unit that is designed for supplying the flow medium to the gas bearing.

### BACKGROUND

The present disclosure pertains to compressor technology, specifically to oil-free compressor devices that utilize gas bearings for supporting rotors.

Usually, a compressor or compactor comprises a rotatably mounted rotor and a housing arranged around the rotor. A to-be-compressed flow medium flows into the compressor via a flow inlet and is there compressed in a compressor stage, i.e. the pressure of the flow medium is increased. The compressed flow medium exits the compressor via a flow outlet.

The rotor needs to be mounted, with oil bearings operated with oil being employed, amongst others. However, a problem with this is that the flow medium might mix with the oil, which has to be avoided. Seals have to be used to address this issue. In many cases, so-called dry gas seals are employed which offer the advantage of bringing about a, by comparison, good seal. However, operation and mode of functioning of such dry gas seals are, by comparison, complex.

Available apart from oil-operated bearings are aerostatic bearings or gas bearings that offer the option to operate rotating shafts oil-free, contact-free, and almost without friction.

Such bearings can be operated using almost any gas, from nitrogen to filtered process gas and/or flow medium, with the carrying capacity, however, being highly dependent on delivery pressure and size.

Operating a compressor device using oil is, by comparison, expensive and complex. It would be desirable to provide a compressor unit that can be operated without oil.

Against this background, it is an object of the invention to specify a compressor device and a method that can be operated oil-free.

### SUMMARY

The invention relates to a compressor device, having a compressor unit designed for compressing flow media, wherein the compressor unit comprises a rotatably mounted rotor and a housing arranged around the rotor, with gas bearings designed for supporting the rotor.

Furthermore, the invention relates to a method for operating a compressor device, wherein the compressor device has a compressor unit, wherein the compressor unit has a rotatably mounted rotor and a housing arranged around the rotor, wherein gas bearings are arranged that are designed for supporting the rotor.

This object is attained by a compressor device, comprising a compressor unit designed for compressing flow media, wherein the compressor unit comprises a rotatably mounted rotor and a housing arranged around the rotor, with gas bearings designed for supporting the rotor, wherein the gas bearing is operable by a flow medium, wherein a fluidic connection is arranged between the gas bearing and the compressor unit that is designed for supplying the flow medium to the gas bearing.

Furthermore, the objective is further attained by a method for operating a compressor device, wherein the compressor device has a compressor unit, wherein the compressor unit has a rotatably mounted rotor and a housing arranged around the rotor, wherein gas bearings are arranged that are designed for supporting the rotor, wherein the gas bearings are supplied with the flow medium coming from the compressor unit.

This invention allows for oil-free operation of the compressor device.

In order to eliminate the oil unit completely, all rotors in the train run in gas-lubricated gas bearings.

The most effective way to implement this is to supply all gas bearings with process gas and/or flow medium from the discharge end during operation and to eliminate the oil unit.

Thus, the train can work without transmission and is powered by a high-speed electric motor. This offers the opportunity to not only eliminate the oil unit but also the dry gas seals.

To make this possible, motor housing and coupling spacer have to be gastight and pressure-resistant. The train is then encased and all gas escaping from the bearings can return to the process.

This invention can be applied to multiple trains with more than one compactor or compressor, multiplying the cost savings.

The invention is based on the idea that the gas bearings can be operated with the process gas and/or flow medium. Here, the flow medium is diverted from the compression process and supplies the gas bearings. After flowing through the gas bearing, the flow medium is returned to the compressor unit.

Advantageous developments are specified in the dependent claims.

The main difference is applying the concept of gas-lubricated bearings consistently to the entire compressor train instead of focusing only on the compressor unit itself. The advantages described below can be obtained in this manner.

Oil units can be dispensed with. The use of dry gas seals can be reduced.

The invention increases reliability and no transmission is required.

The characteristics, features and advantages of this invention described above, as well as the manner in which these are achieved, will be more clearly and fully understood in connection with the following description of the exemplary embodiments, which will be explained in more detail in connection with the drawings.

Identical components or components with the same function are labeled with the same reference numerals.

Exemplary embodiments of the invention will be described hereinafter with reference to the drawings. These are not intended to represent the exemplary embodiments to scale; rather, where useful for explanation, the drawing is executed in a schematic and/or slightly distorted form. With regard to additions to the teachings immediately visible in the drawing, reference is made to the relevant prior art.

### BRIEF DESCRIPTION OF THE DRAWINGS

In the drawings:

FIG. 1 shows a schematic depiction of an embodiment of a device according to the invention.

### DETAILED DESCRIPTION

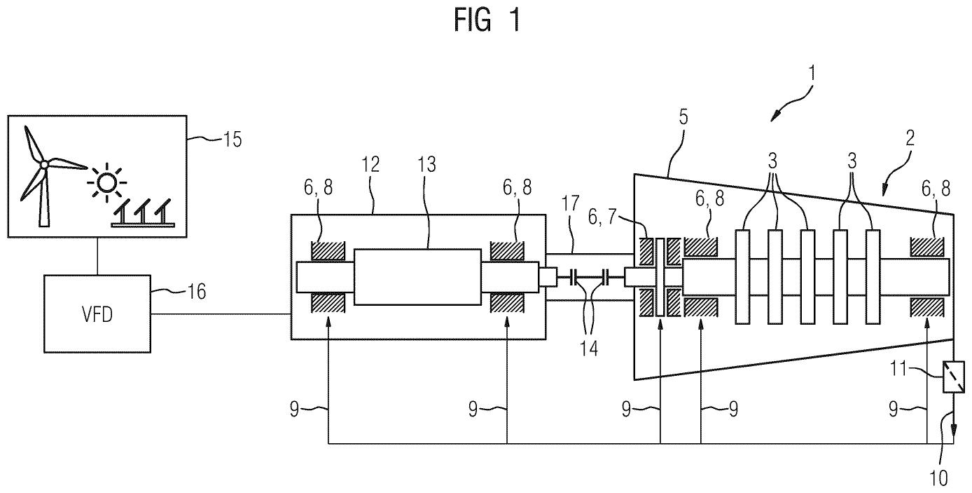

FIG. 1 shows a schematic depiction of an embodiment of the invention. In particular, FIG. 1 shows a compressor device 1. The compressor device 1 is designed for compressing process gases, which may also be referred to as flow media. For that purpose, the compressor device 1 has a compressor unit 2 designed for compressing the flow medium. Here, FIG. 1 shows a compressor unit 2 designed as a turbo compressor that has multiple stages 3.

The compressor unit 2 comprises a rotatably mounted rotor 4. A housing 5 is arranged around the rotatably mounted rotor 4. Furthermore, the compressor unit 2 has multiple gas bearings 6 designed for supporting the rotor 4. The rotor 4 shown in FIG. 1 is mounted with one axial gas bearing 7 and two radial bearings 8.

The gas bearings 6 each have one feeder line 9 for a gas medium, wherein the gas bearings 6 are designed such that the rotor 4 is mounted on a gas film consisting of the gas medium.

The compressor unit 2 has a flow inlet for the flow medium (not shown). After the flow medium is being compressed further after each stage 3, the flow medium flows out via a flow outlet 10 in which a flap 11 is arranged. A part of the process medium flowing out of the flow outlet 10 is in fluidic connection with the feeder lines 9, so that, according to the invention, the gas bearings 6 are supplied with the flow medium from the compressor unit 2.

After the flow medium has flowed through the gas bearings 6, the flow medium is returned to the flow inlet via suitable means. This creates a closed system for supplying the gas bearings 6 with the flow medium.

The compressor device 1 further has a drive 12. The drive 12 is designed such that it imparts a rotation to the rotor 4 in the compressor unit 2. For this purpose, the drive 12 has a drive rotor 13 designed for driving the rotor 4. For this purpose, the drive rotor 13 has to be in torque-transferring connection with the rotor 4. This is achieved via couplings 14.

The drive rotor 13 is also rotatably mounted, again with the gas bearings 6 being used. Shown in FIG. 1 are two gas bearings 6 designed as radial bearings 8. These gas bearings 6 are also supplied with the flow medium via the feeder lines 9. Thus, the gas bearings 6 of the radial bearings 8 for the drive rotor 13 are also in fluidic connection with the flow medium.

Here, the drive 12 can be designed as an electric motor. The electric motor may be supplied with electric current from renewable energies 15, for example wind energy and solar energy. Usually, a converter 16 is needed for using electric current from renewable energies 15.

In order to obtain a closed circuit with the flow medium for supplying the gas bearings 6, the compressor device 1 has to be designed to be hermetic and/or gastight. This means that the drive has to be executed in a gastight manner. Likewise, a coupling housing 17 has to be arranged around the couplings 14. Therefore, the gas bearings 6 are supplied in a closed circuit, wherein the gas bearings 6 are supplied with the flow medium from the compressor unit 2. The entire compressor device 1 is executed so that no flow medium can flow out of the compressor device 1 on the way to or away from the gas bearing 6.

Although the invention has been illustrated and described in more detail by the preferred exemplary embodiment, the invention is not restricted by the disclosed examples, and other variations may be derived therefrom by a person skilled in the art without departing from the scope of protection of the invention.

1. A compressor device, comprising
a compressor unit designed for compressing flow media,
wherein the compressor unit comprises a rotatably mounted rotor and a housing arranged around the rotor,
with gas bearings designed for supporting the rotor,
characterized in that
the gas bearing is operable by a flow medium, wherein a fluidic connection is arranged between the gas bearing and the compressor unit that is designed for supplying the flow medium to the gas bearing.

2. The compressor device according to claim 1,
wherein the gas bearing is designed as an axial gas bearing for axially supporting the rotor.

3. The compressor device according to claim 1,
wherein the gas bearing is designed as a radial gas bearing for radially supporting the rotor.

4. The compressor device according to claim 2,
wherein the compressor unit has a flow inlet for the flow medium,
wherein the compressor unit has at least one compression stage in which a flow medium is compressed,
wherein the compressor unit has a flow outlet designed for outflowing of the compressed flow medium,
wherein the gas bearings are in fluidic connection with the flow outlet.

5. The compressor device according to claim 4,
wherein the flow medium is in fluidic connection with the flow inlet after flowing through the gas bearing.

6. The compressor device according to claim 1, further comprising
a drive having a drive rotor and designed for driving the rotor,
wherein the drive has gas bearings designed for supporting the drive rotor,
wherein the gas bearings are in fluidic connection with the flow medium.

7. The compressor device according to claim 6,
wherein the drive is designed as an electric motor.

8. The compressor device according to claim 6,
wherein a coupling that is designed to be gastight is arranged between the rotor and the drive rotor.

9. The compressor device according to claim 1,
wherein the compressor device is designed to be gastight.

10. A method for operating a compressor device,
wherein the compressor device has a compressor unit, wherein the compressor unit has a rotatably mounted rotor and a housing arranged around the rotor, wherein gas bearings are arranged that are designed for supporting the rotor, wherein the gas bearings are supplied with a flow medium coming from the compressor unit.

11. The method according to claim 10,
wherein the compressor device is designed such that supplying the gas bearings takes place within the compressor device.

12. The method according to claim 10,
wherein the rotor is powered with a drive, in particular an electric motor, wherein the drive has a drive rotor, wherein the drive rotor is supported with gas bearings that are supplied with the flow medium from the compressor unit.

13. The method according to claim 10,
wherein the flow medium flows back into the compressor unit after flowing through the gas bearings.

14. The method according to claim 12,
wherein a coupling is arranged between the drive and the compressor unit.

15. The method according to claim 10,
wherein the compressor device is designed hermetically such that supplying the gas bearings with the flow medium takes place within the compressor device.
